(19) United States
(12) Patent Application Publication
(10) Pub. No.: US 2026/0039804 A1
(43) Pub. Date: Feb. 5, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Weijia ZHU, Los Angeles, CA (US); Wenjie Zhang, Beijing (CN); Yuwen He, Los Angeles, CA (US); Li Zhang, Los Angeles, CA (US)

(21) Appl. No.: 19/356,909

(22) Filed: Oct. 13, 2025

Related U.S. Application Data
(63) Continuation of application No. PCT/CN2024/087600, filed on Apr. 12, 2024.

(30) Foreign Application Priority Data
Apr. 13, 2023 (WO) PCT/CN2023/088144

(51) Int. Cl. H04N 19/107; H04N 19/176

(52) U.S. Cl. CPC H04N 19/107; H04N 19/176

(57) ABSTRACT

Embodiments of the present disclosure provide a solution for video processing. A method for video processing is proposed. In the method, pre-analysis information for a current video block of a video is determined. The pre-analysis information comprises at least one of: at least one pre-intra mode, or at least one pre-inter motion vector. A coding mode is determined for the current video block based on the pre-analysis information. The current video block is coded based on the coding mode.

### CROSS REFERENCE TO RELATED APPLICATIONS

This application is a continuation of International Application No. PCT/CN2024/087600, filed on Apr. 12, 2024, which claims the benefit of International Application No. PCT/CN2023/088144 filed on Apr. 13, 2023. The entire contents of these applications are hereby incorporated by reference in their entireties.

### FIELD

Embodiments of the present disclosure relate generally to video coding techniques, and more particularly, to pre-analysis for video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally very low, which is undesirable.

### SUMMARY

Embodiments of the present disclosure provide a solution for video processing.

In a first aspect, a method for video processing is proposed. The method comprises: determining pre-analysis information for a current video block of a video, the pre-analysis information comprising at least one of: at least one pre-intra mode, or at least one pre-inter motion vector; determining a coding mode for the current video block based on the pre-analysis information; and coding the current video block based on the coding mode. The method in accordance with the first aspect of the present disclosure uses information of for guiding the encoding process. In this way, the encoding process can be improved.

In a second aspect, another method for video processing is proposed. The method comprises: performing a pre-analysis for a current video block of a video, wherein at least one of: a pre-intra cost determination, a pre-inter cost determination, a pre-intra mode selection, or a pre-inter motion estimation is skipped for the current video block; and coding the current video block based on the pre-analysis. The method in accordance with the second aspect of the present disclosure skips one or more process of the pre-analysis. In this way, the encoding complexity can be reduced, and thus the encoding process can be improved.

In a third aspect, another method for video processing is proposed. The method comprises: dividing a current frame of a video into a plurality of regions: performing a pre-analysis for the plurality of regions in parallel; and coding the current frame based on the pre-analysis. The method in accordance with the third aspect of the present disclosure applies the pre-analysis in parallel for a plurality of regions in a frame. In this way, the encoding complexity can be reduced, and thus the encoding process can be improved.

In a fourth aspect, an apparatus for video processing is proposed. The apparatus comprises a processor and a non-transitory memory with instructions thereon. The instructions upon execution by the processor, cause the processor to perform a method in accordance with the first, second, or third aspect of the present disclosure.

In a fifth aspect, a non-transitory computer-readable storage medium is proposed. The non-transitory computer-readable storage medium stores instructions that cause a processor to perform a method in accordance with the first, second, or third aspect of the present disclosure.

In a sixth aspect, another non-transitory computer-readable recording medium is proposed. The non-transitory computer-readable recording medium stores a bitstream of a video which is generated by a method performed by an apparatus for video processing. The method comprises: determining pre-analysis information for a current video block of the video, the pre-analysis information comprising at least one of: at least one pre-intra mode, or at least one pre-inter motion vector; determining a coding mode for the current video block based on the pre-analysis information; and generating the bitstream based on the coding mode.

In a seventh aspect, another non-transitory computer-readable recording medium is proposed. The non-transitory computer-readable recording medium stores a bitstream of a video which is generated by a method performed by an apparatus for video processing. The method comprises: determining pre-analysis information for a current video block of the video, the pre-analysis information comprising at least one of: at least one pre-intra mode, or at least one pre-inter motion vector; determining a coding mode for the current video block based on the pre-analysis information: generating the bitstream based on the coding mode; and storing the bitstream in a non-transitory computer-readable recording medium.

In an eighth aspect, another non-transitory computer-readable recording medium is proposed. The non-transitory computer-readable recording medium stores a bitstream of a video which is generated by a method performed by an apparatus for video processing. The method comprises: performing a pre-analysis for a current video block of the video, wherein at least one of: a pre-intra cost determination, a pre-inter cost determination, a pre-intra mode selection, or a pre-inter motion estimation is skipped for the current video block; and generating the bitstream based on the pre-analysis.

In a ninth aspect, a method for storing a bitstream of a video is proposed. The method comprises: performing a pre-analysis for a current video block of the video, wherein at least one of: a pre-intra cost determination, a pre-inter cost determination, a pre-intra mode selection, or a pre-inter motion estimation is skipped for the current video block: generating the bitstream based on the pre-analysis; and storing the bitstream in a non-transitory computer-readable recording medium.

In a tenth aspect, another non-transitory computer-readable recording medium is proposed. The non-transitory computer-readable recording medium stores a bitstream of a video which is generated by a method performed by an apparatus for video processing. The method comprises: dividing a current frame of a video into a plurality of regions: performing a pre-analysis for the plurality of regions in parallel; and generating the bitstream based on the pre-analysis.

In an eleventh aspect, a method for storing a bitstream of a video is proposed. The method comprises: dividing a current frame of a video into a plurality of regions: performing a pre-analysis for the plurality of regions in parallel: generating the bitstream based on the pre-analysis; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an overview of HEVC standard;

FIG. 5 illustrates 33 intra prediction directions;

FIG. 6 illustrates a mapping between intra prediction direction and intra prediction mode;

FIG. 7 illustrates an intra boundary filter example;

FIG. 8 illustrates an intra prediction angle for 4:2:2 chroma format;

FIG. 9 illustrates an illustration of a translational motion;

FIG. 10 illustrates a derivation process for merge candidates list construction;

FIG. 11 illustrates positions of spatial merge candidates;

FIG. 12 illustrates candidate pairs considered for redundancy check of spatial merge candidates;

FIG. 13 illustrates positions for the second PU of N×2N and 2N×N partitions;

FIG. 14 illustrates an illustration of motion vector scaling for temporal merge candidate;

FIG. 15 illustrates candidate positions for temporal merge candidate, C0 and C1;

FIG. 16 illustrates example of combined bi-predictive merge candidate;

FIG. 17 illustrates a derivation process for motion vector prediction candidates;

FIG. 18 illustrates an illustration of motion vector scaling for spatial motion vector candidate;

FIG. 19 illustrates a flowchart of a method for video processing in accordance with some embodiments of the present disclosure;

FIG. 20 illustrates a flowchart of another method for video processing in accordance with some embodiments of the present disclosure;

FIG. 21 illustrates a flowchart of another method for video processing in accordance with some embodiments of the present disclosure; and

FIG. 22 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” arc intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

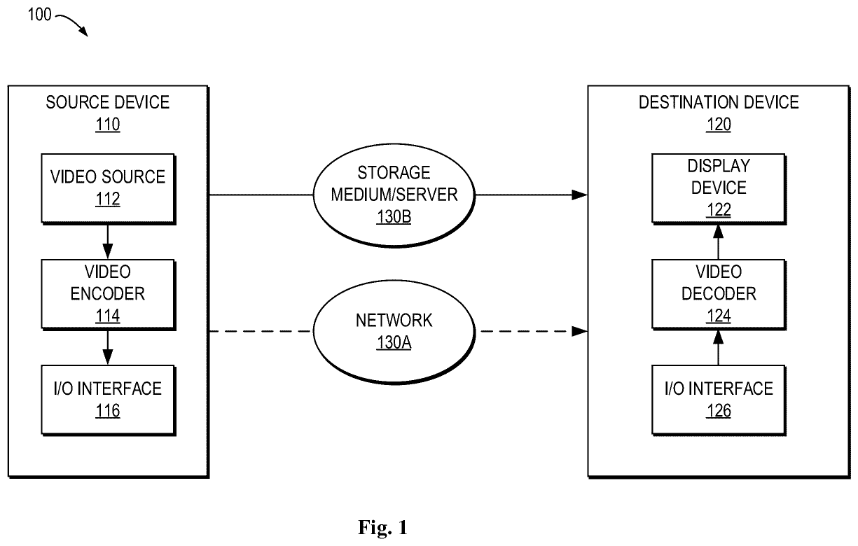

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard. Versatile Video Coding (VVC) standard and other current and/or further standards.

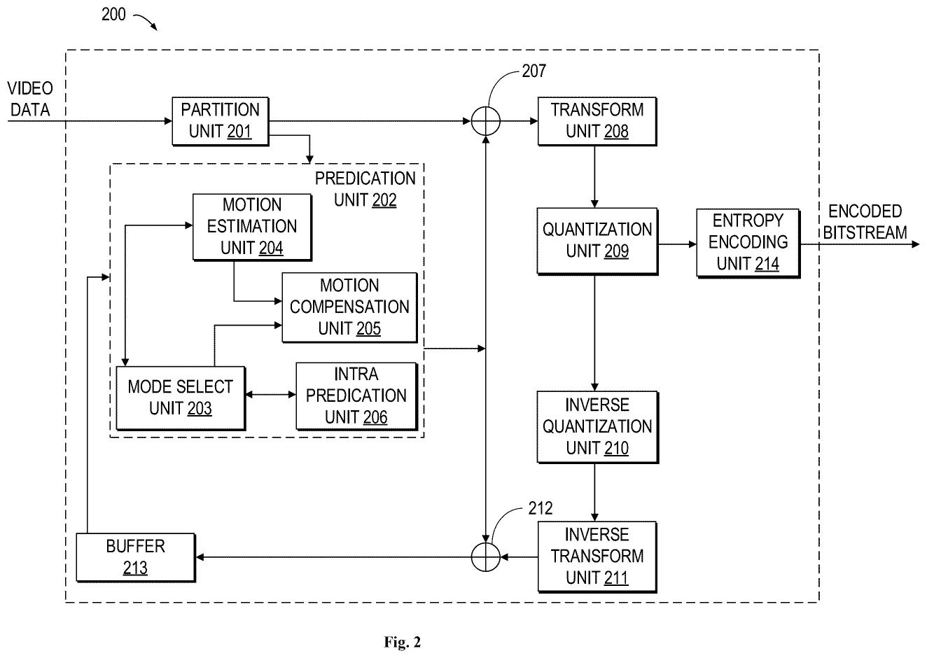

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

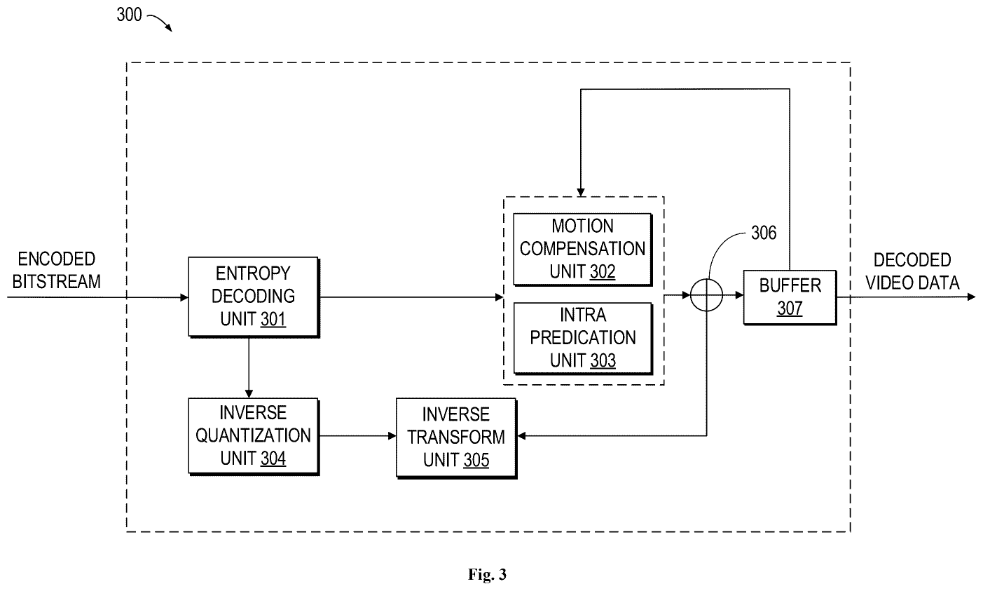

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1 Brief Summary

This disclosure is related to video encoding with pre-analysis technologies. Specifically, it is related to the pre-analysis design in video encoding. It may be applied to existing video encoders, such as VTM, x264, x265, HM, VVenC and others. It may also be applicable to future video coding encoders or video codecs.

### 2 Introduction

### 2.1 High Efficiency Video Coding (HEVC) Standard

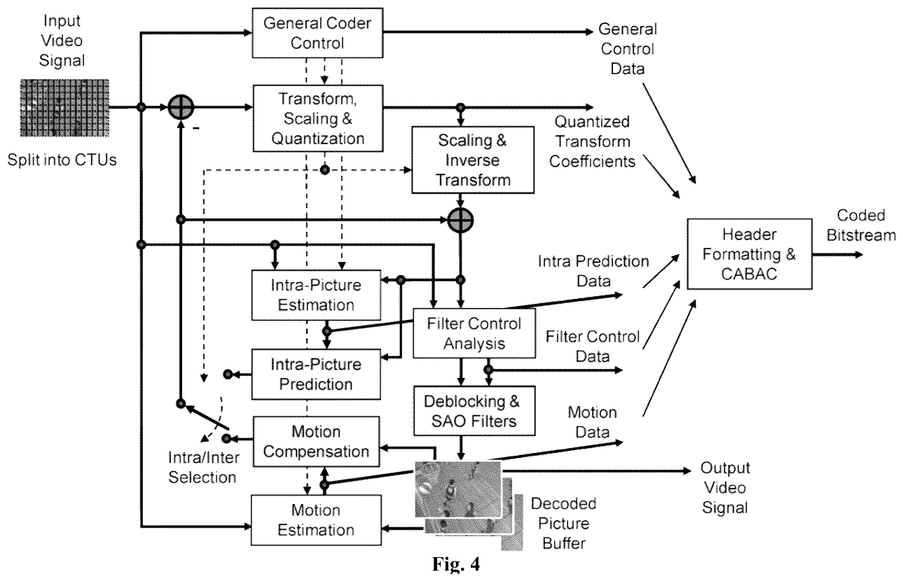

FIG. 4 shows the functional diagram of a typical hybrid HEVC encoder, including a block partitioning that splits a video picture into CTUs with a fixed block size. For each CTU, quad-tree is employed to partition it into several blocks, called coding units. For each coding unit, block-based intra or inter prediction is performed, then the generated residue is transformed and quantized. Finally, the context adaptive binary arithmetic coding (CABAC) as an entropy coding method is employed for bit-stream generation. The deblocking and sample adaptive offset are applied for reconstruction picture's in-loop filtering before the reconstructed picture is stored in the decoded picture buffer (DPB).

### 2.2 Introduction of Pre-Analysis

In real applications, the bitrate is usually limited by the network bandwidth. Thus, rate control (RC) algorithms are essential to an encoder. To estimate the required number of bits for each frame, a rate control algorithm needs to evaluate the complexity of each frame feed into the encoder. Then the encoder decides a suitable quantization parameter based on the evaluated complexity. This complexity evaluation process called pre-analysis. To evaluate the complexity more easily, when a frame is ready for pre-analysis, the frame is first divided into several 8×8 blocks. Then the intra and inter cost are calculated for each block and the block cost is the minimal one between the intra and inter cost. The frame complexity is represented by the summation of all block cost.

To obtain a more accurate frame complexity, an encoder usually minimizes the cost of each block. For instance, in the intra pre-analysis, several intra modes candidates are tested and the intra mode with a minimal cost is the best one. In the inter pre-analysis, a motion search algorithm is performed and the motion vector with a minimal cost is to be selected. Finally, the intra and inter pre-analysis cost are compared and the smaller one is the cost for the current block.

In an encoder, the intra and inter cost employs a rate-distortion based criterion. The distortion in the pre-analysis is measured based on the original signal and the prediction signal. And, several metrics, sum-square error (SSE), sum of absolute differences (SAD), and sum of absolute transformed differences (SATD), can be employed for distortion calculations. And, for encoding complexity consideration, the rate is usually measured by the number of bins instead of the number of bits cost by the current prediction method. In addition, the lambda in the criterion is derived based on a fixed quantization parameter which is given by the encoder.

Furthermore, the prediction signal is generated on the original samples of a frame rather than reconstruction samples in the pre-analysis. Therefore, the transform and quantization related processes are completely avoided in the pre-analysis for complexity reduction.

### 2.3 Intra Prediction

Intra prediction is a spatial prediction tool. It predicts a block by extrapolating its neighboring pixels. In the pre-analysis, the intra prediction is for the intra cost calculation. To capture the arbitrary edge directions presented in natural video, in the existing video codec, several intra prediction modes corresponding to different prediction angles are supported. In the intra pre-analysis, the intra modes can be employed for cost calculation. The details of HEVC intra prediction are depicted below.

Intra prediction involves producing samples for a given TB using samples previously reconstructed in the considered color channel. The intra prediction mode is separately signaled for the luma and chroma channels, with the chroma channel intra prediction mode optionally dependent on the luma channel intra prediction mode via the ‘DM_CHROMA’ mode. Although the intra prediction mode is signaled at the PB level, the intra prediction process is applied at the TB level, in accordance with the residual quad-tree hierarchy for the CU, thereby allowing the coding of one TB to have an effect on the coding of the next TB within the CU, and therefore reducing the distance to the samples used as reference values.

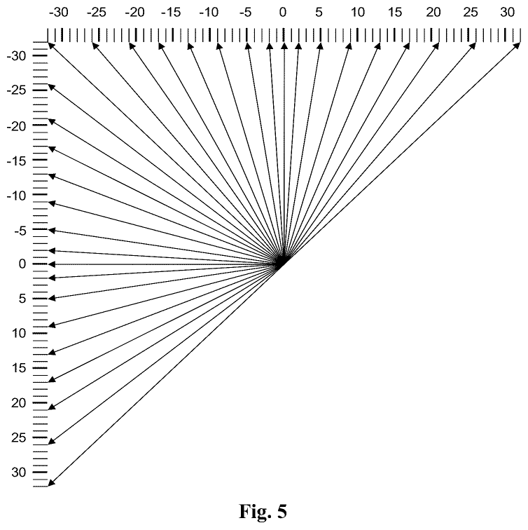

HEVC includes 35 intra prediction modes—a DC mode, a planar mode and 33 directional, or ‘angular’ intra prediction modes. The 33 angular intra prediction modes are illustrated below, as shown in FIG. 5.

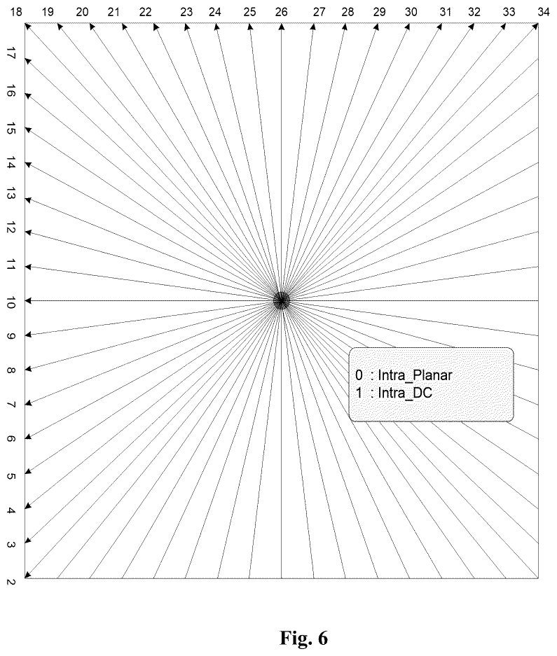

The mapping between the direction of each of the angular intra prediction modes and the intra prediction mode number is specified as below, as shown in FIG. 6.

For PBs associated with chroma colour channels, the intra prediction mode is specified as either planar, DC, horizontal, vertical, ‘DM_CHROMA’ mode or sometimes diagonal mode ‘34’. Table 1 shows the rule specifying the chroma colour channel PB intra prediction mode given the luma colour channel PB intra prediction mode and the ‘intra_chroma_pred_mode’ syntax element.

Note for chroma formats 4:2:2 and 4:2:0, the chroma PB may overlap two or four (respectively) luma PBs; in this case the luma direction for DM_CHROMA is taken from the top left of these luma PBs.

The DM_CHROMA mode indicates that the intra prediction mode of the luma colour channel PB is applied to the chroma colour channel PBs. Since this is relatively common, the most-probable-mode coding scheme of the intra_chroma_pred_mode is biased in favour of this mode being selected.

TABLE 1
Mapping between intra prediction direction
and intra prediction mode for chroma.

| | Luma intra prediction direction, X | | | | |
|---|---|---|---|---|---|
| | | | | | Otherwise |
| intra_chroma_pred_mode | 0 | 26 | 10 | 1 | (0 <= X <= 34) |
| 0 | 34 | 0 | 0 | 0 | 0 |
| 1 | 26 | 34 | 26 | 26 | 26 |
| 2 | 10 | 10 | 34 | 10 | 10 |
| 3 | 1 | 1 | 1 | 34 | 1 |
| 4 (DM_CHROMA) | 0 | 26 | 10 | 1 | X |

### 2.3.1 Filtering of Neighbouring Samples

The neighbouring samples filtering process for intra prediction is skipped when intra_smoothing_disabled_flag is set to 1. The intra reference smoothing filter is disabled in common test conditions only when sequence-level lossless coding is used.

If the intra reference smoothing filter is enabled, then for the luma component, the neighbouring samples used for generation of intra-predicted samples are filtered. The filtering further is controlled by the given intra prediction mode and transform block size. If the intra prediction mode is DC or the transform block size is equal to 4×4, neighbouring samples are not filtered. If the distance between the given intra prediction mode and vertical mode (or horizontal mode) is larger than predefined threshold, the filtering process remains enabled (otherwise the filtering process becomes disabled). The predefined threshold is specified in the following table where nT represents the TB size.

TABLE 2
Specification of predefined threshold
for various transform block sizes.

| | nT = 8 | nT = 16 | nT = 32 |
|---|---|---|---|
| Threshold | 7 | 1 | 0 |

If filtering remains enabled, then either a neighbouring sample filtering, [1, 2, 1] or a bi-linear filter are used. The bi-linear filtering is used if all of the following conditions are true (otherwise the neighbouring sample filtering is used):
strong_intra_smoothing_enabled_flag is equal to 1.
luma channel under consideration.
transform block size is equal to 32.

$$Abs ( p [ - 1 ] [ - 1 ] + p [ nT * 2 - 1 ] [ - 1 ] - 2 * p [ n T - 1 ] [ - 1 ] ) < ( 1 << ( BitDepthY - 5 ) ) . Abs ( p [ - 1 ] [ - 1 ] + p [ - 1 ] [ nT * 2 - 1 ] - 2 * p [ - 1 ] [ n T - 1 ] ) < ( 1 << ( BitDepthY - 5 ) ) .$$

### 2.3.2 Intra Boundary Filter

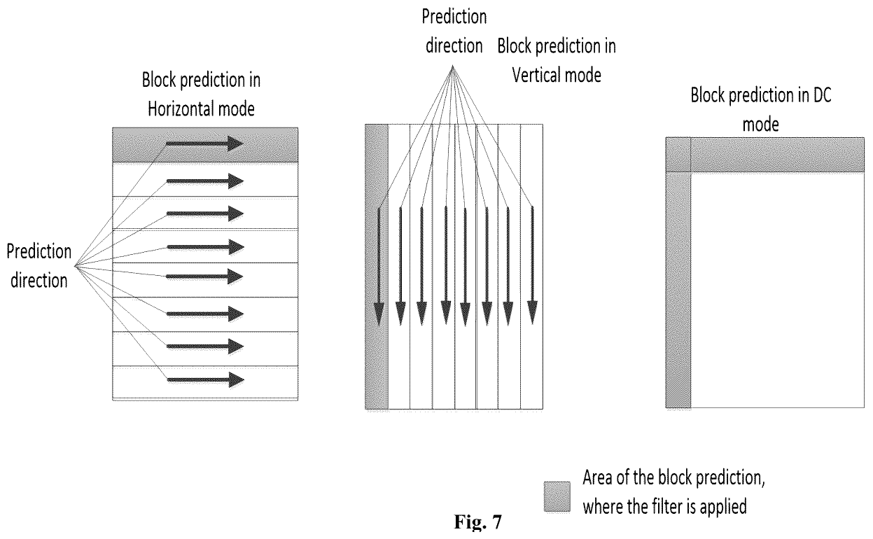

When reconstructing intra-predicted TBs an intra-boundary filter (IBF) may be used when predicting samples along the left and/or top edges of the TB for PBs using horizontal, vertical and DC intra prediction modes, as shown in FIG. 7. For horizontal and vertical intra prediction modes, the IBF is disabled when implicit RDPCM and transquant bypass are enabled. For the DC intra prediction mode, the IBF is applied to the luma channel of TBs smaller than 32×32.

The intra boundary filter is defined with respect to an array of predicted samples p as input and predSamples as output as follows:
For horizontal intra-prediction applied to luma transform blocks of size less than 32×32, and disableIntraBoundary Filter is equal to 0, the following filtering applies with x=0 . . . nTbS−1, y=0;

$$predSamples [ x ] [ y ] = Clip {1}_{Y} ( p [ - 1 ] [ y ] + ( ( p [ x ] [ - 1 ] - p [ - 1 ] [ - 1 ] ) >> 1 ) ) .$$

For vertical intra-prediction applied to luma transform blocks of size less than 32×32, and disableIntraBoundary Filter is equal to 0, the following filtering applies with x=0 . . . nTbS−1, y=0;

$$predSamples [ x ] [ y ] = Clip {1}_{Y} ( p [ x ] [ - 1 ] + ( ( p [ - 1 ] [ y ] - p [ - 1 ] [ - 1 ] ) >> 1 ) ) .$$

For DC intra-prediction applied to luma transform blocks of size less than 32×32 the following filtering applies with x=0 . . . nTbS−1, y=0 (where de Val is the DC predictor):

$$predSamples [ 0 ] [ 0 ] = ( p [ - 1 ] [ 0 ] + 2 * dcVal + p [ 0 ] [ - 1 ] + 2 ) >> 2. \\ predSamples [ x ] [ 0 ] = ( p [ x ] [ - 1 ] + 3 * dcVal + 2 ) >> 2 , with x = 1 … nTbS - 1. \\ predSamples [ 0 ] [ y ] = ( p [ - 1 ] [ y ] + 3 * dcVal + 2 ) >> 2 , with y = 1 … nTbS - 1 .$$

### 2.3.3 4:2:2 Chroma Format Mode Adjustment

When the DM_CHROMA mode is selected (i.e., intra_chroma_pred_mode is equal to 4) and the 4:2:2 chroma format is in use, the intra prediction mode for a chroma PB is derived from intra prediction mode for the corresponding luma PB and 4:2:0/4:4:4 chroma as specified in the following table.

TABLE 3
Specification of intra prediction mode for 4:2:2 chroma.

| intra pred mode | 0 | 1 | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|---|---|
| intra pred mode | 0 | 1 | 2 | 2 | 2 | 2 | 2 | 4 | 6 | 8 | 10 | 12 | 14 | 16 | 18 | 18 | 18 | 18 |
| for 4:2:2 chroma | | | | | | | | | | | | | | | | | | |

| intra pred mode | 18 | 19 | 20 | 21 | 22 | 23 | 24 | 25 | 26 | 27 | 28 | 29 | 30 | 31 | 32 | 33 | 34 |
|---|---|---|---|---|---|---|---|---|---|---|---|---|---|---|---|---|---|
| intra pred mode | 22 | 22 | 23 | 23 | 24 | 24 | 25 | 25 | 26 | 27 | 27 | 28 | 28 | 29 | 29 | 30 | 30 |
| for 4:2:2 chroma | | | | | | | | | | | | | | | | | |

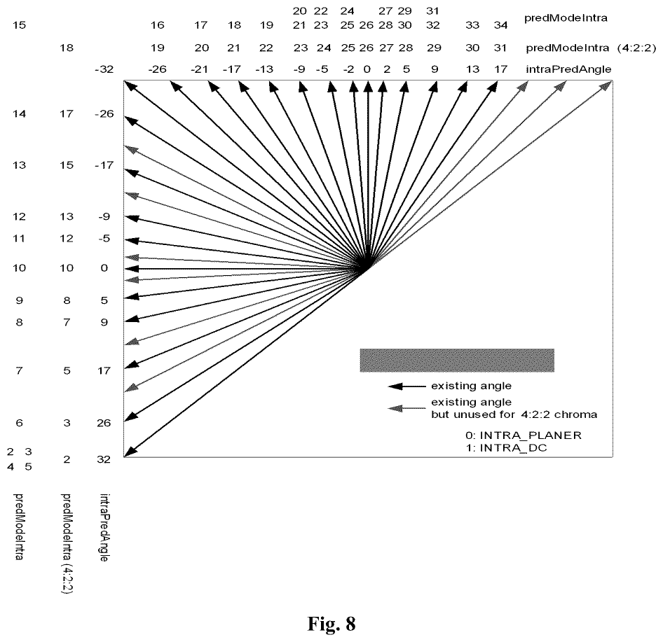

The result of this mapping table is illustrated in the following FIG. 8, which shows the intra prediction angles for the 4:2:2 chroma format.

### 2.2.2 Inter Prediction

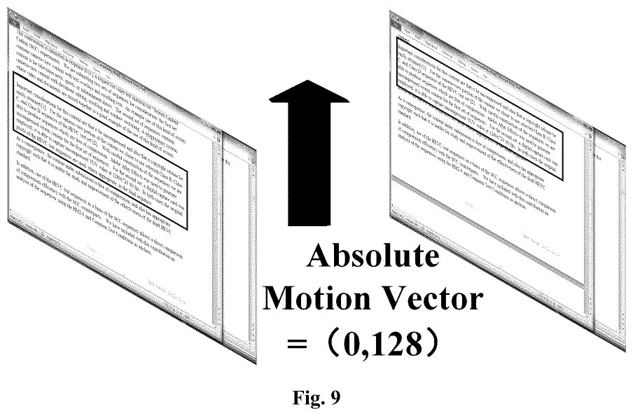

Inter prediction is employed to capture translational motions of moving objects. An example of translational motions is shown in FIG. 9. An encoder employs motion estimation methods to find the best matching blocks in past frames for a current block. And the details of HEVC inter prediction are described below.

### 2.4 Inter Prediction in HEVC/H.265

Each inter-predicted prediction unit (PU) has motion parameters for one or two reference picture lists. Motion parameters include a motion vector and a reference picture index. Usage of one of the two reference picture lists may also be signalled using inter_pred_idc. Motion vectors may be explicitly coded as deltas relative to predictors.

When a coding unit (CU) is coded with skip mode, one PU is associated with the CU, and there are no significant residual coefficients, no coded motion vector delta or reference picture index. A merge mode is specified whereby the motion parameters for the current PU are obtained from neighbouring PUs, including spatial and temporal candidates. The merge mode can be applied to any inter-predicted PU, not only for skip mode. The alternative to merge mode is the explicit transmission of motion parameters, where motion vector (to be more precise, motion vector differences (MVD) compared to a motion vector predictor), corresponding reference picture index for each reference picture list and reference picture list usage are signalled explicitly per each PU. Such a mode is named Advanced motion vector prediction (AMVP) in this disclosure.

When signalling indicates that one of the two reference picture lists is to be used, the PU is produced from one block of samples. This is referred to as ‘uni-prediction’. Uni-prediction is available both for P-slices and B-slices.

When signalling indicates that both of the reference picture lists are to be used, the PU is produced from two blocks of samples. This is referred to as ‘bi-prediction’. Bi-prediction is available for B-slices only.

The following text provides the details on the inter prediction modes specified in HEVC. The description will start with the merge mode.

### 2.4.1 Reference Picture List

In HEVC, the term inter prediction is used to denote prediction derived from data elements (e.g., sample values or motion vectors) of reference pictures other than the current decoded picture. Like in H.264/AVC, a picture can be predicted from multiple reference pictures. The reference pictures that are used for inter prediction are organized in one or more reference picture lists. The reference index identifies which of the reference pictures in the list should be used for creating the prediction signal.

A single reference picture list, List 0, is used for a P slice and two reference picture lists, List 0 and List 1 are used for B slices. It should be noted reference pictures included in List 0/1 could be from past and future pictures in terms of capturing/display order.

### 2.4.2 Merge Mode

### 2.4.2.1 Derivation of Candidates for Merge Mode

When a PU is predicted using merge mode, an index pointing to an entry in the merge candidates list is parsed from the bitstream and used to retrieve the motion information. The construction of this list is specified in the HEVC standard and can be summarized according to the following sequence of steps:
Step 1: Initial candidates derivation.
   Step 1.1: Spatial candidates derivation.
   Step 1.2: Redundancy check for spatial candidates.
   Step 1.3: Temporal candidates derivation.
Step 2: Additional candidates insertion.
   Step 2.1: Creation of bi-predictive candidates.
   Step 2.2: Insertion of zero motion candidates.

These steps are also schematically depicted in FIG. 10. For spatial merge candidate derivation, a maximum of four merge candidates are selected among candidates that are located in five different positions. For temporal merge candidate derivation, a maximum of one merge candidate is selected among two candidates. Since constant number of candidates for each PU is assumed at decoder, additional candidates are generated when the number of candidates obtained from step 1 does not reach the maximum number of merge candidate (MaxNumMergeCand) which is signalled in slice header. Since the number of candidates is constant, index of best merge candidate is encoded using truncated unary binarization (TU). If the size of CU is equal to 8, all the PUs of the current CU share a single merge candidate list, which is identical to the merge candidate list of the 2N×2N prediction unit.

In the following, the operations associated with the aforementioned steps are detailed.

### 2.4.2.2 Spatial Candidates Derivation

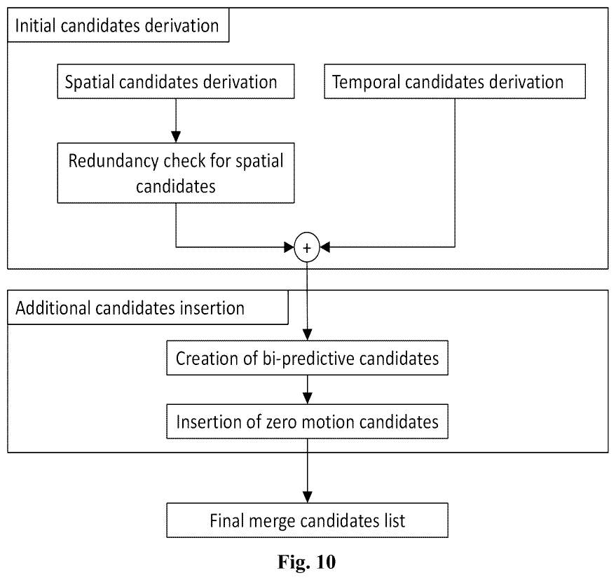

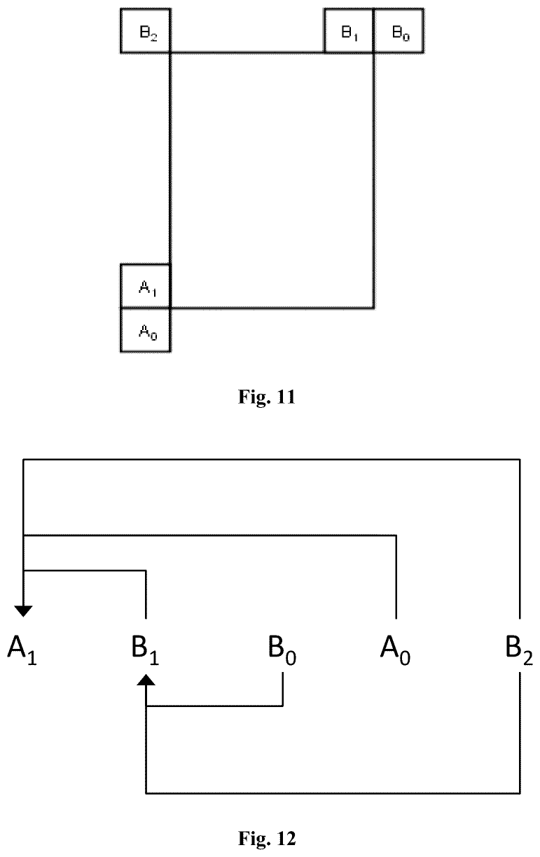

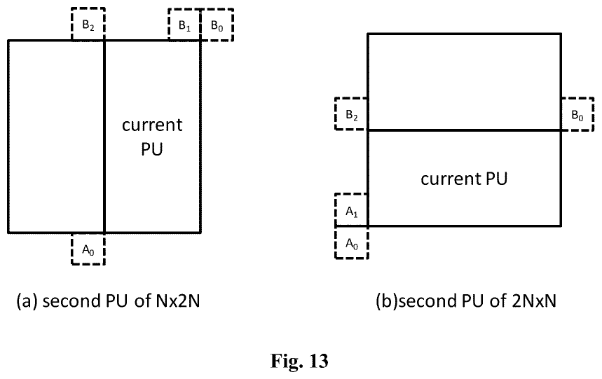

In the derivation of spatial merge candidates, a maximum of four merge candidates are selected among candidates located in the positions depicted in FIG. 11. The order of derivation is A₁, B₁, B₀, A₀ and B₂. Position Be is considered only when any PU of position A₁, B₁, B₀, A₀ is not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. Instead only the pairs linked with an arrow in FIG. 12 are considered and a candidate is only added to the list if the corresponding candidate used for redundancy check has not the same motion information. Another source of duplicate motion information is the “second PU” associated with partitions different from 2N×2N. As an example. FIG. 13 depicts the second PU for the case of N×2N and 2N×N, respectively. When the current PU is partitioned as N×2N, candidate at position A₁ is not considered for list construction. In fact, by adding this candidate will lead to two prediction units having the same motion information, which is redundant to just have one PU in a coding unit. Similarly, position B₁ is not considered when the current PU is partitioned as 2N×N.

### 2.4.2.3 Temporal Candidates Derivation

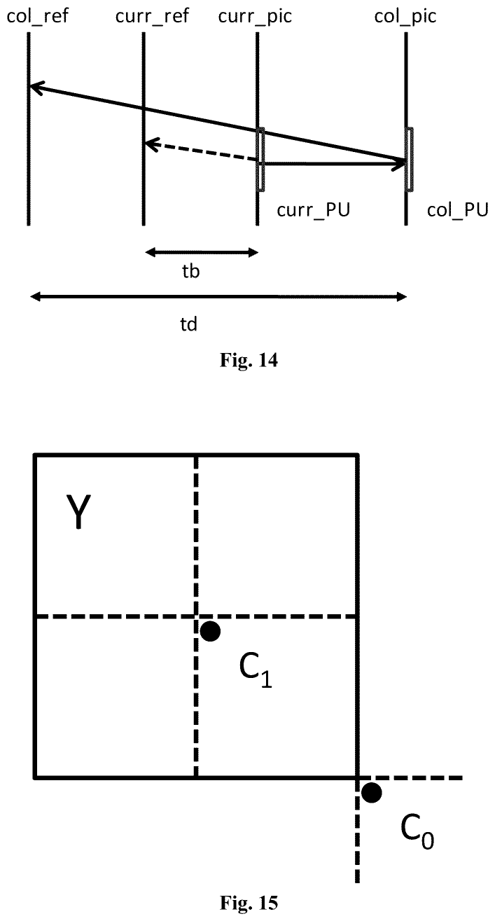

In this step, only one candidate is added to the list. Particularly, in the derivation of this temporal merge candidate, a scaled motion vector is derived based on co-located PU belonging to the picture which has the smallest POC difference with current picture within the given reference picture list. The reference picture list to be used for derivation of the co-located PU is explicitly signalled in the slice header. The scaled motion vector for temporal merge candidate is obtained as illustrated by the dotted line in FIG. 14, which is scaled from the motion vector of the co-located PU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero. A practical realization of the scaling process is described in the HEVC specification. For a B-slice, two motion vectors, one is for reference picture list 0 and the other is for reference picture list 1, are obtained and combined to make the bi-predictive merge candidate.

In the co-located PU (Y) belonging to the reference frame, the position for the temporal candidate is selected between candidates C₀ and C₁, as depicted in FIG. 15. If PU at position C₀ is not available, is intra coded, or is outside of the current coding tree unit (CTU aka. LCU, largest coding unit) row, position C₁ is used. Otherwise, position C₀ is used in the derivation of the temporal merge candidate.

### 2.4.2.4 Additional Candidates Insertion

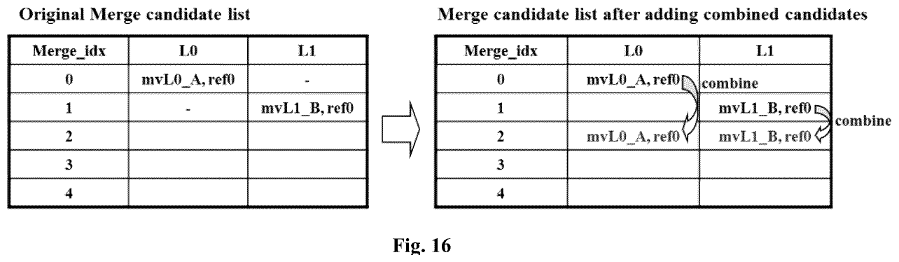

Besides spatial and temporal merge candidates, there are two additional types of merge candidates: combined bi-predictive merge candidate and zero merge candidate. Combined bi-predictive merge candidates are generated by utilizing spatial and temporal merge candidates. Combined bi-predictive merge candidate is used for B-Slice only. The combined bi-predictive candidates are generated by combining the first reference picture list motion parameters of an initial candidate with the second reference picture list motion parameters of another. If these two tuples provide different motion hypotheses, they will form a new bi-predictive candidate. As an example. FIG. 16 depicts the case when two candidates in the original list (on the left), which have myL0 and refIdxL0 or mvL1 and refIdxL1, are used to create a combined bi-predictive merge candidate added to the final list (on the right). There are numerous rules regarding the combinations which are considered to generate these additional merge candidates.

Zero motion candidates are inserted to fill the remaining entries in the merge candidates list and therefore hit the MaxNumMergeCand capacity. These candidates have zero spatial displacement and a reference picture index which starts from zero and increases every time a new zero motion candidate is added to the list. Finally, no redundancy check is performed on these candidates.

### 2.4.3 AMVP

AMVP exploits spatio-temporal correlation of motion vector with neighbouring PUs, which is used for explicit transmission of motion parameters. For each reference picture list, a motion vector candidate list is constructed by firstly checking availability of left, above temporally neighbouring PU positions, removing redundant candidates and adding zero vector to make the candidate list to be constant length. Then, the encoder can select the best predictor from the candidate list and transmit the corresponding index indicating the chosen candidate. Similarly with merge index signalling, the index of the best motion vector candidate is encoded using truncated unary. The maximum value to be encoded in this case is 2. In the following sections, details about derivation process of motion vector prediction candidate are provided.

### 2.4.3.1 Derivation of AMVP Candidates

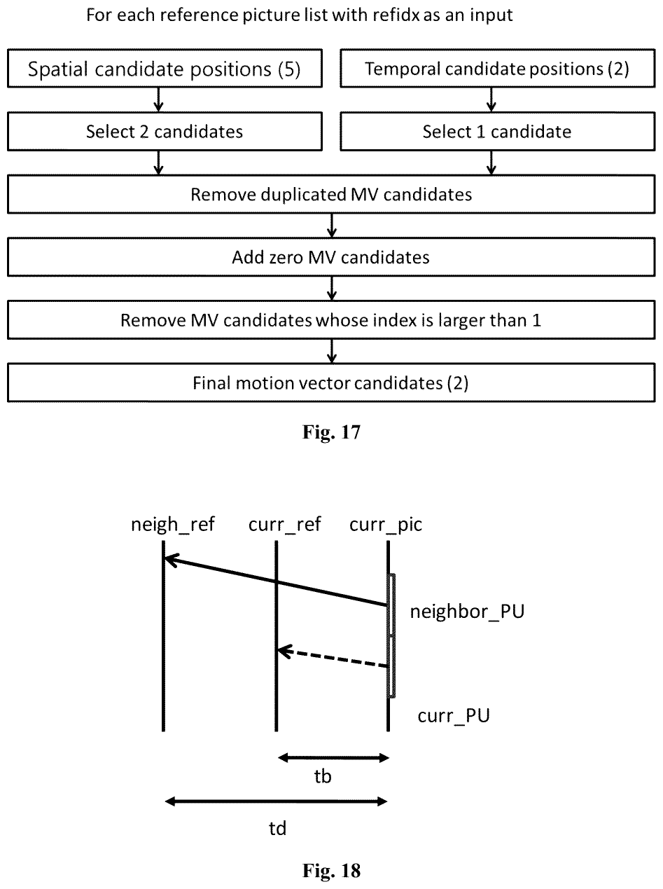

FIG. 17 summarizes derivation process for motion vector prediction candidate.

In motion vector prediction, two types of motion vector candidates are considered: spatial motion vector candidate and temporal motion vector candidate. For spatial motion vector candidate derivation, two motion vector candidates are eventually derived based on motion vectors of each PU located in five different positions as depicted in the FIG. 11.

For temporal motion vector candidate derivation, one motion vector candidate is selected from two candidates, which are derived based on two different co-located positions. After the first list of spatio-temporal candidates is made, duplicated motion vector candidates in the list are removed. If the number of potential candidates is larger than two, motion vector candidates whose reference picture index within the associated reference picture list is larger than 1 are removed from the list. If the number of spatio-temporal motion vector candidates is smaller than two, additional zero motion vector candidates is added to the list.

### 2.4.3.2 Spatial Motion Vector Candidates

In the derivation of spatial motion vector candidates, a maximum of two candidates are considered among five potential candidates, which are derived from PUs located in positions as depicted in FIG. 18, those positions being the same as those of motion merge. The order of derivation for the left side of the current PU is defined as A₀, A₁, and scaled A₀, scaled A₁. The order of derivation for the above side of the current PU is defined as B₀, B₁, B₂, scaled B₀, scaled B₁, scaled B₂. For each side there are therefore four cases that can be used as motion vector candidate, with two cases not required to use spatial scaling, and two cases where spatial scaling is used. The four different cases are summarized as follows.
No spatial scaling
   (1) Same reference picture list, and same reference picture index (same POC).
   (2) Different reference picture list, but same reference picture (same POC).
Spatial scaling
   (3) Same reference picture list, but different reference picture (different POC).
   (4) Different reference picture list, and different reference picture (different POC).

The no-spatial-scaling cases are checked first followed by the spatial scaling. Spatial scaling is considered when the POC is different between the reference picture of the neighbouring PU and that of the current PU regardless of reference picture list. If all PUs of left candidates are not available or are intra coded, scaling for the above motion vector is allowed to help parallel derivation of left and above MV candidates. Otherwise, spatial scaling is not allowed for the above motion vector.

In a spatial scaling process, the motion vector of the neighbouring PU is scaled in a similar manner as for temporal scaling, as depicted as FIG. 18. The main difference is that the reference picture list and index of current PU is given as input: the actual scaling process is the same as that of temporal scaling.

### 2.4.3.3 Temporal Motion Vector Candidates

Apart for the reference picture index derivation, all processes for the derivation of temporal merge candidates are the same as for the derivation of spatial motion vector candidates (see FIG. 17). The reference picture index is signalled to the decoder.

### 3 Problems

The pre-analysis performance is essential to the rate control performance, and it could be further improved based on the following observations.
1. The information of pre-analysis is a good guide for the encoding process. This information could be referred by some encoding modules like intra mode decision and inter motion estimation process.
2. The pre-analysis complexity significantly affects the encoding complexity. The encoding process can be started only when the pre-analysis is done. Consequently, the complexity of pre-analysis should be as low as possible and its complexity could be reduced by some elaborated algorithms.
3. The pre-analysis could be processed in parallel for speed up if the computing resource is enough.

### 4 Detailed Solutions

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner.

In the following bullets, pre-intra may denote the intra pre-analysis, and pre-inter may denote the inter pre-analysis.

### Pre-Analysis Guided Encoding

1. The pre-intra mode and pre-inter motion vectors may guide the encoding.

The following bullets may be only applied when a current block is an 8×8 block.
a. In one example, a current block may consider the pre-intra modes as high priority candidates.
   i. In one example, a current block may use its pre-intra mode as the best intra mode.
      1. Alternatively, in one example, the intra mode candidates for a current block may only include a small set of all intra modes.
         a. In one example, the small set may include pre-intra modes and their adjacent ones.
         i. In one example, if the pre-intra mode is a DC/PLANAR mode, the small set may only include DC and/or PLANAR mode.
b. In one example, a current block may consider the pre-inter motion vectors (MVs) as high priority candidates.
   i. In one example, the pre-inter motion vector may be employed as the best motion vector for a current block.
   ii. In one example, the initial search list in the motion estimation for a current block may include the pre-inter motion vectors.
c. In one example, the best mode selected from pre-analysis may be tested first in the encoding.
   i. In one example, only the best mode from pre-analysis is tested.
   ii. In one example, the early termination may be checked after the best pre-analysis mode is checked. For example, if the rate-distortion is smaller enough, the encoder will terminate the mode checking for the current CU. Otherwise it will continue to check the remaining mode.

The following bullets may be only applied when a current block is N×N and N is greater than 8. In such a case, the current block may have more than one pre-intra mode and more than one pre-inter motion vectors.
d. In one example, the pre-intra mode of any 8×8 block in a current block may be used as the best intra mode for the block.
   i. In one example, the pre-intra modes with highest occurrence among all intra modes of the 8×8 blocks may be used as the best intra mode for the block.
   ii. In one example, the intra mode candidates for a current block may only include a small set of all intra modes and the small set may include pre-intra modes of one or more 8×8 blocks in the block.
      1. In one example, the small set for a current block may include the adjacent ones of those pre-intra modes as well.
   iii. In one example, if one of more pre-intra modes are DC/PLANAR modes, the small set for a current block may only include DC and/or PLANAR mode.
e. In one example, the pre-inter motion vector of any 8×8 block in a current block may be used as the best one for the block.
   i. In one example, the pre-inter motion vector with highest occurrence among all motion vectors of the 8×8 blocks may be used as the best one for the current block.
      1. Alternatively, in one example, the closet pre-inter motion vector among all motion vectors of the 8×8 blocks may be used as the best one for the current block.
   ii. In one example, the initial search list for a current block may include the pre-inter motion vectors of one or more 8×8 blocks in the current block.
f. In the above bullets, the pre intra modes may be applied to intra luma coding and/or intra chroma coding.
g. In the above bullets, the pre motion vectors may be scaled when applied to the encoding process.
2. The pre-intra cost and pre-inter motion cost may be used to guide how the encoder perform.

In the following bullets, if a current block is N×N and N is equal to 8, its pre-intra cost and pre-inter cost may denote the cost computed when the intra and inter pre-analysis re performed on the current block. If a current block is N×N and N is greater than 8, its pre-intra cost and pre-inter cost may denote the summation of the pre-intra and pre-inter costs of all 8×8 blocks in the current block.
a. In one example, for a current block, if the pre-inter cost is much larger than the pre-intra cost, one or more following processes may be performed.
   i. Skip skip-modes tests.
   ii. Skip early-skip checks.
   iii. Skip inter-modes tests.
   iv. Skip non-square inter modes tests.
   V. Skip merge-modes tests.
   vi. Skip half-pel motion estimation.
   vii. Skip quarter-pel motion estimation.
   viii. Only test intra coding.
b. In one example, for a current block, if the pre-inter cost is much smaller than the pre-intra cost, one or more following processes may be performed.
   i. Skip intra modes tests.
   ii. Test a small set of intra modes instead of the full candidates list.
      1. In one example, the small set may include one or more intra modes from the full intra modes.

### Intra and Inter Pre-Analysis Speed Up

3. The pre-intra cost and/or pre-inter cost may be skipped for some blocks. The costs for these blocks may be set to the costs of their neighbouring blocks.
   a. In one example, a neighbouring block may denote a left/above/left-above/right-above neighbor.
   b. In one example, the pre-cost of a block may a set to the minimal costs of its neighbours.
   c. In one example, if the pre-cost of a block is obtained by copying from its neighbours, the pre-cost may be further adjusted.
      i. In one example, the pre-cost may be adjusted by multiplying a factor which may be controlled by the encoder.
   d. In one example, the pre-cost may be adjusted by multiplying a factor which may be controlled by the encoder.
4. The pre-intra mode decision and/or pre-inter motion estimation may be skipped for some blocks. The pre-intra modes and/or pre-inter motion vectors of these blocks may derive from their neighbouring blocks.
   a. In one example, a neighbouring block may denote a left/above/left-above/right-above neighbor.
   b. In one example, the pre-intra mode selection may be skipped for a block, and the best pre-intra mode may be set to the intra mode of one of its neighbours.
      i. In such a case, in one example, the pre-intra cost may be recalculated for the block.
         1. In one example, only the distortion part in the pre-intra cost may be recalculated for the block.
         2. In one example, the rate part for in pre-intra cost may copy from one of its neighbours.
   c. In one example, the pre-inter motion estimation may be skipped for a block, and the best pre-inter motion vector may be derived from one of its neighbours.
      i. In such a case, in one example, the pre-inter cost may be recalculated for the block.
         1. In one example, only the distortion part in the pre-inter cost may be recalculated for the block.
         2. In one example, the rate part for in pre-inter cost may copy from one of its neighbours.

### Parallel Pre-Analysis Processing

5. The pre-analysis may be parallel processed.
   a. In one example, a frame may be divided into several N×M regions and the pre-analysis for each region is parallel processed.
      i. In one example, a block in one region may not use the information of a block in the other regions.
      ii. In one example, a block in one region may not refer to the information of a block in the other regions.
      iii. In the above bullets, the information may include:
         1. Intra mode.
         a. Most probable intra modes.
         2. Motion vector.
         a. Motion vector prediction.
         3. Pre-intra cost.
         a. Pre-intra distortion and/or rate factors.
         4. Pre-inter cost.
         a. Pre-inter distortion and/or rate factors.

### General Aspects

6. The N, M and/or above bullets may be applied based on
   a. Video resolution.
   b. Slice/tile group type and/or picture type.
   c. Colour component (e.g., may be only applied on Cb or Cr).
   d. Temporal layer ID.
   e. Profiles/Levels/Tiers of a standard.
7. The above bullets could be applied to pre-analysis related variances.
8. The above bullets could be applied to the pre-analysis process in any encoders or its variances.

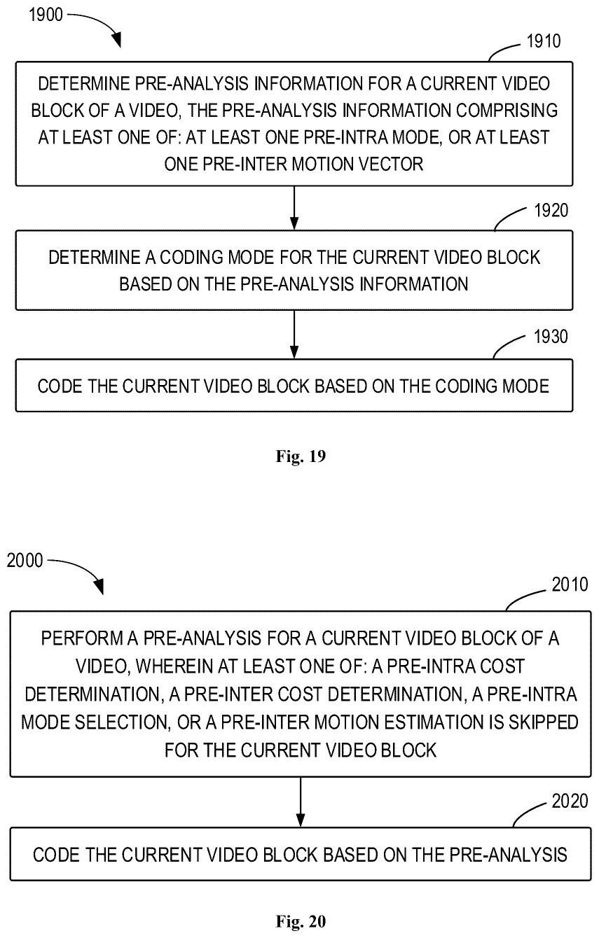

FIG. 19 illustrates a flowchart of a method 1900 for video processing in accordance with embodiments of the present disclosure.

At block 1910, pre-analysis information for a current video block of a video, is determined. The pre-analysis information comprises at least one of: at least one pre-intra mode, or at least one pre-inter motion vector.

At block 1920, a coding mode for the current video block is determined based on the pre-analysis information. As used herein, the term “coding mode” may refer to a coding method or coding tool to be applied for coding the current video block. The term “coding mode” may also be referred to as a “coding tool” or a “coding module”. In embodiments where coding the current video block comprises encoding the current video block, the coding mode may be referred to as an “encoding mode”, “encoding tool”, or “encoding module” to be used in the encoding process. Determining an encoding mode may be referred to as “guiding the encoding process”. In other words, the coding process such as the encoding process can be guided by the pre-analysis information.

At block 1930, the current video block is coded based on the coding mode. For example, the current video block is encoded into a bitstream of the video based on the coding mode.

The method 1900 enables uses information of for guiding the coding process such as the encoding process. In this way, the encoding process can be improved.

In some embodiments, a size of the current video block is less than or equal to a threshold size, and the at least one pre-intra mode comprises a pre-intra mode, priority of the pre-intra mode is higher than a further candidate intra mode. As used herein, the threshold size may be 8×8, or any other suitbable size.

In some embodiments, a plurality of candidate intra modes is available for the current video block, and the plurality of candidate intra modes comprises a subset of a whole sets of intra modes.

In some embodiments, the subset of intra modes comprises the pre-intra mode and at least one adjacent intra mode of the pre-intra mode.

In some embodiments, if the pre-intra mode is DC mode or PLANAR mode, the subset of intra modes only comprises at least one of: the DC mode, or the PLANAR mode.

In some embodiments, a priority of the pre-intra mode is highest among a plurality of candidate intra modes of the current video block.

In some embodiments, a size of the current video block is less than or equal to a threshold size, and at least one priority of the at least one pre-inter motion vector is higher than a further inter motion vector candidate.

In some embodiments, an initial search list in a motion estimation for the current video block comprises the at least one pre-inter motion vector, or the pre-inter motion vector is a target motion vector for the current video block.

In some embodiments, the coding mode determined based on the pre-analysis information comprises a pre-analysis mode, the pre-analysis mode is tested before a further coding mode during the coding of the current video block.

In some embodiments, the further coding mode is not tested.

In some embodiments, an early termination is checked after checking the pre-analysis mode, and during the early termination checking, if a rate distortion cost is less than a threshold, the mode checking for the current video block is terminated, and if the rate distortion cost is greater than or equal to the threshold, remaining modes are checked.

In some embodiments, a size of the current video block is greater than a threshold size, and the at least one pre-intra mode comprises a plurality of pre-intra modes for a plurality of subblocks of the current video block, a size of a subblock being less than or equal to the threshold size.

In some embodiments, the plurality of pre-intra modes is used as target intra modes for the current video block, or wherein at least one of the plurality of pre-intra modes with a highest occurrence among the plurality of pre-intra modes is used as at least one target intra mode for the current video block. As used herein, the target intra mode may be referred to as a best intra mode which may be used for coding the current video block.

In some embodiments, a plurality of candidate intra modes is available for the current video block, and the plurality of candidate intra modes comprises a subset of a whole sets of intra modes, and wherein the subset of intra modes comprises at least one of the plurality of pre-intra modes.

In some embodiments, the subset of intra modes further comprises at least one adjacent intra mode of the at least one of the plurality of pre-intra modes.

In some embodiments, if the at least one of the plurality of pre-intra modes comprises DC mode or PLANAR mode, the subset of intra modes only comprises at least one of: the DC mode, or the PLANAR mode.

In some embodiments, a size of the current video block is greater than a threshold size, and the at least one pre-inter motion vector comprises a plurality of pre-inter motion vectors for a plurality of subblocks of the current video block.

In some embodiments, the plurality of pre-inter motion vectors is used as at least one target motion vector for the current video block, or wherein at least one of the plurality of pre-inter motion vectors with a highest occurrence among the plurality of pre-inter motion vectors is used as the at least one target motion vector for the current video block, or wherein at least one pre-inter motion vector closest to the current video block among the plurality of pre-inter motion vectors is used as the at least one target motion vector for the current video block.

In some embodiments, an initial search list in a motion estimation for the current video block comprises at least one of the plurality of pre-inter motion vectors.

In some embodiments, the at least one pre-intra mode is applied to at least one of: intra luma coding, or intra chroma coding.

In some embodiments, the at least one pre-inter motion vector is scaled before being applied to an encoding process.

In some embodiments, the pre-analysis information further comprises at least one of: a pre-intra cost, or a pre-inter cost, and at least one of the pre-intra cost or the pre-inter cost is used to guide the coding of the current video block.

In some embodiments, a size of the current video block is less than or equal to a threshold size, and the pre-intra cost and the pre-inter cost is determined based on an intra pre-analysis and an inter pre-analysis performed on the current video block.

In some embodiments, a size of the current video block is greater than a threshold size, the pre-intra cost is a sum of a plurality of pre-intra costs of a plurality of subblocks in the current video block, and the pre-inter cost is a sum of a plurality of pre-inter costs of the plurality of subblocks in the current video block.

In some embodiments, for the current video block, if the pre-inter cost is larger than the pre-intra cost, at least one of the following processes is performed: a skip of a skip modes test, a skip of an early-skip check, a skip of an inter-modes test, a skip of a non-square inter modes test, a skip of a merge-modes test, a skip of a half-pel motion estimation, a skip of a quarter-pel motion estimation, or only test intra coding.

In some embodiments, for the current video block, if the pre-inter cost is smaller than the pre-intra cost, at least one of the following processes is performed: a skip of an intra modes test, or a test of a subset of intra modes instead of a full candidate list of intra modes for the current video block.

In some embodiments, the subset of intra modes comprises one or more intra modes from the full candidate list of intra modes.

In some embodiments, coding the current video block comprises encoding the current video block into a bitstream of the video.

According to further embodiments of the present disclosure, a non-transitory computer-readable recording medium is provided. The non-transitory computer-readable recording medium stores a bitstream of a video which is generated by a method performed by an apparatus for video processing. The method comprises: determining pre-analysis information for a current video block of the video, the pre-analysis information comprising at least one of: at least one pre-intra mode, or at least one pre-inter motion vector; determining a coding mode for the current video block based on the pre-analysis information; and generating the bitstream based on the coding mode.

According to still further embodiments of the present disclosure, a method for storing bitstream of a video is provided. The method comprises: determining pre-analysis information for a current video block of the video, the pre-analysis information comprising at least one of: at least one pre-intra mode, or at least one pre-inter motion vector; determining a coding mode for the current video block based on the pre-analysis information; generating the bitstream based on the coding mode; and storing the bitstream in a non-transitory computer-readable recording medium.

FIG. 20 illustrates a flowchart of a method 2000 for video processing in accordance with embodiments of the present disclosure.

At block 2010, a pre-analysis for a current video block of a video is performed. At least one of: a pre-intra cost determination, a pre-inter cost determination, a pre-intra mode selection, or a pre-inter motion estimation is skipped for the current video block. The current video block may be of 8×8, or any other suitbable size.

At block 2020, the current video block is coded based on the pre-analysis. The method 2000 enables skipping one or more process of the pre-analysis. In this way, the coding complexity such as the encoding complexity can be reduced, and thus the coding process such as encoding process can be improved.

In some embodiments, a pre-cost of the current video block is set to be a pre-cost of a neighboring block of the current video block, the pre-cost comprising at least one of a pre-intra cost or a pre-inter cost of the current video block.

In some embodiments, the pre-cost is set to be a minimum pre-intra cost or a minimum pre-inter cost of a plurality of neighboring blocks of the current video block.

In some embodiments, the pre-cost of the current video block is obtained from a neighboring block of the current video block, and the pre-cost is further adjusted for the current video block.

In some embodiments, the pre-cost is adjusted by multiplying a factor, the factor being controlled by an encoder for encoding the current video block.

In some embodiments, at least one of a pre-intra mode or a pre-inter motion vector of the current video block is determined from at least one neighboring block of the current video block.

In some embodiments, the at least one neighboring block comprises at least one of: a left neighboring block, an above neighboring block, a left-above neighboring block, or a right-above neighboring block.

In some embodiments, the pre-intra mode selection is skipped for the current video block, and a target pre-intra mode of the current video block is set to be an intra mode of at least one neighboring block of the current video block.

In some embodiments, a pre-intra cost is recalculated for the current video block.

In some embodiments, a distortion part of the pre-intra cost is recalculated for the current video block, and a rate part of the pre-intra cost is copied from the at least one neighboring block.

In some embodiments, the pre-inter motion estimation is skipped for the current video block, and a target pre-inter motion vector is determined from at least one neighboring block of the current video block.

In some embodiments, a pre-inter cost is recalculated for the current video block.

In some embodiments, a distortion part of the pre-inter cost is recalculated for the current video block, and a rate part of the pre-inter cost is copied from the at least one neighboring block.

In some embodiments, coding the current video block comprises encoding the current video block into a bitstream of the video.

According to further embodiments of the present disclosure, a non-transitory computer-readable recording medium is provided. The non-transitory computer-readable recording medium stores a bitstream of a video which is generated by a method performed by an apparatus for video processing. The method comprises: performing a pre-analysis for a current video block of the video, wherein at least one of: a pre-intra cost determination, a pre-inter cost determination, a pre-intra mode selection, or a pre-inter motion estimation is skipped for the current video block; and generating the bitstream based on the pre-analysis.

According to still further embodiments of the present disclosure, a method for storing bitstream of a video is provided. The method comprises: performing a pre-analysis for a current video block of the video, wherein at least one of: a pre-intra cost determination, a pre-inter cost determination, a pre-intra mode selection, or a pre-inter motion estimation is skipped for the current video block: generating the bitstream based on the pre-analysis; and storing the bitstream in a non-transitory computer-readable recording medium.

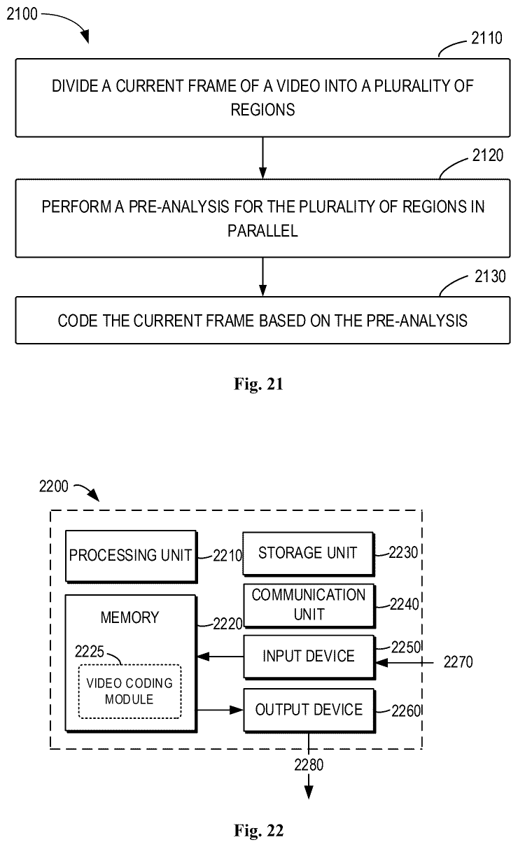

FIG. 21 illustrates a flowchart of a method 2100 for video processing in accordance with embodiments of the present disclosure.

At block 2110, a current frame of a video is divided into a plurality of regions. For example, a size of the region may be N×M. N and M being positive integers.

At block 2120, a pre-analysis is performed for the plurality of regions in parallel.

At block 2130, the current frame is coded based on the pre-analysis. For example, the current frame may be encoded into a bitstream of the video based on the pre-analysis.

The method 2100 enables applying the pre-analysis in parallel for a plurality of regions in a frame. In this way, the coding complexity such as the encoding complexity can be reduced, and thus the coding process such as the encoding process can be improved.

In some embodiments, information of a first block in a first region of the plurality of regions is not used or referred to by a second block in a second region of the plurality of regions.

In some embodiments, the information comprises at least one of: an intra mode, a motion vector, a pre-intra cost, or a pre-inter cost.

In some embodiments, the intra mode comprises a most probably intra mode, or wherein the motion vector comprises a motion vector prediction, or wherein the pre-intra cost comprises a pre-intra distortion and a rate factor, or wherein the pre-inter cost comprises a pre-inter distortion and a rate factor.

In some embodiments, a size of a region of the current video block is based on at least one of: a video resolution, a slice type, a tile group type, a picture type, a color component, a temporal layer identifier, a profile, a level, or a tier of a standard.

In some embodiments, coding the current frame comprises encoding the current frame into a bitstream of the video.

According to further embodiments of the present disclosure, a non-transitory computer-readable recording medium is provided. The non-transitory computer-readable recording medium stores a bitstream of a video which is generated by a method performed by an apparatus for video processing. The method comprises: dividing a current frame of a video into a plurality of regions: performing a pre-analysis for the plurality of regions in parallel; and generating the bitstream based on the pre-analysis.

According to still further embodiments of the present disclosure, a method for storing bitstream of a video is provided. The method comprises: dividing a current frame of a video into a plurality of regions; performing a pre-analysis for the plurality of regions in parallel; generating the bitstream based on the pre-analysis; and storing the bitstream in a non-transitory computer-readable recording medium.

In some embodiments, an applying of the method 1900, the method 2000, and/or the method 2100 is based on at least one of: a video resolution, a slice type, a tile group type, a picture type, a color component, a temporal layer identifier, a profile, a level, or a tier of a standard. For example, the method 1900, the method 2000, and/or the method 2100 may be only applied on Cb or Cr.

In some embodiments, the method 1900, the method 2000, and/or the method 2100 may be applied to at least one of: a pre-analysis related variance, or a pre-analysis process in an encoder, or a variance of the pre-analysis process in the encoder.

It is to be understood that the method 1900, the method 2000, and/or the method 2100 can be applied separately, or in any combination.

Implementations of the present disclosure can be described in view of the following clauses, the features of which can be combined in any reasonable manner.

Clause 1. A method for video processing, comprising: determining pre-analysis information for a current video block of a video, the pre-analysis information comprising at least one of: at least one pre-intra mode, or at least one pre-inter motion vector; determining a coding mode for the current video block based on the pre-analysis information; and coding the current video block based on the coding mode.

Clause 2. The method of clause 1, wherein a size of the current video block is less than or equal to a threshold size, and the at least one pre-intra mode comprises a pre-intra mode, priority of the pre-intra mode is higher than a further candidate intra mode.

Clause 3. The method of clause 2, wherein a plurality of candidate intra modes is available for the current video block, and the plurality of candidate intra modes comprises a subset of a whole sets of intra modes.

Clause 4. The method of clause 3, wherein the subset of intra modes comprises the pre-intra mode and at least one adjacent intra mode of the pre-intra mode.

Clause 5. The method of clause 4, wherein if the pre-intra mode is DC mode or PLANAR mode, the subset of intra modes only comprises at least one of: the DC mode, or the PLANAR mode.

Clause 6. The method of any of clauses 2-5, wherein a priority of the pre-intra mode is highest among a plurality of candidate intra modes of the current video block.

Clause 7. The method of any of clauses 1-6, wherein a size of the current video block is less than or equal to a threshold size, and at least one priority of the at least one pre-inter motion vector is higher than a further inter motion vector candidate.

Clause 8. The method of clause 7, wherein an initial search list in a motion estimation for the current video block comprises the at least one pre-inter motion vector, or wherein the pre-inter motion vector is a target motion vector for the current video block.

Clause 9. The method of any of clauses 1-8, wherein the coding mode determined based on the pre-analysis information comprises a pre-analysis mode, the pre-analysis mode is tested before a further coding mode during the coding of the current video block.

Clause 10. The method of clause 9, wherein the further coding mode is not tested.

Clause 11. The method of clause 9, wherein an early termination is checked after checking the pre-analysis mode, and during the early termination checking, if a rate distortion cost is less than a threshold, the mode checking for the current video block is terminated, and if the rate distortion cost is greater than or equal to the threshold, remaining modes are checked.

Clause 12. The method of clause 1, wherein a size of the current video block is greater than a threshold size, and the at least one pre-intra mode comprises a plurality of pre-intra modes for a plurality of subblocks of the current video block, a size of a subblock being less than or equal to the threshold size.

Clause 13. The method of clause 12, wherein the plurality of pre-intra modes is used as target intra modes for the current video block, or wherein at least one of the plurality of pre-intra modes with a highest occurrence among the plurality of pre-intra modes is used as at least one target intra mode for the current video block.

Clause 14. The method of clause 12, wherein a plurality of candidate intra modes is available for the current video block, and the plurality of candidate intra modes comprises a subset of a whole sets of intra modes, and wherein the subset of intra modes comprises at least one of the plurality of pre-intra modes.

Clause 15. The method of clause 14, wherein the subset of intra modes further comprises at least one adjacent intra mode of the at least one of the plurality of pre-intra modes.

Clause 16. The method of clause 14, wherein if the at least one of the plurality of pre-intra modes comprises DC mode or PLANAR mode, the subset of intra modes only comprises at least one of: the DC mode, or the PLANAR mode.

Clause 17. The method of clause 1, wherein a size of the current video block is greater than a threshold size, and the at least one pre-inter motion vector comprises a plurality of pre-inter motion vectors for a plurality of subblocks of the current video block.

Clause 18. The method of clause 17, wherein the plurality of pre-inter motion vectors is used as at least one target motion vector for the current video block, or wherein at least one of the plurality of pre-inter motion vectors with a highest occurrence among the plurality of pre-inter motion vectors is used as the at least one target motion vector for the current video block, or wherein at least one pre-inter motion vector closest to the current video block among the plurality of pre-inter motion vectors is used as the at least one target motion vector for the current video block.

Clause 19. The method of clause 17, wherein an initial search list in a motion estimation for the current video block comprises at least one of the plurality of pre-inter motion vectors.

Clause 20. The method of any of clauses 1-19, wherein the at least one pre-intra mode is applied to at least one of: intra luma coding, or intra chroma coding.

Clause 21. The method of any of clauses 1-20, wherein the at least one pre-inter motion vector is scaled before being applied to an encoding process.

Clause 22. The method of any of clauses 1-21, wherein the pre-analysis information further comprises at least one of: a pre-intra cost, or a pre-inter cost, and at least one of the pre-intra cost or the pre-inter cost is used to guide the coding of the current video block.

Clause 23. The method of clause 22, wherein a size of the current video block is less than or equal to a threshold size, and the pre-intra cost and the pre-inter cost is determined based on an intra pre-analysis and an inter pre-analysis performed on the current video block.

Clause 24. The method of clause 22, wherein a size of the current video block is greater than a threshold size, the pre-intra cost is a sum of a plurality of pre-intra costs of a plurality of subblocks in the current video block, and the pre-inter cost is a sum of a plurality of pre-inter costs of the plurality of subblocks in the current video block.

Clause 25. The method of any of clauses 22-24, wherein for the current video block, if the pre-inter cost is larger than the pre-intra cost, at least one of the following processes is performed: a skip of a skip modes test, a skip of an early-skip check, a skip of an inter-modes test, a skip of a non-square inter modes test, a skip of a merge-modes test, a skip of a half-pel motion estimation, a skip of a quarter-pel motion estimation, or only test intra coding.

Clause 26. The method of any of clauses 22-24, wherein for the current video block, if the pre-inter cost is smaller than the pre-intra cost, at least one of the following processes is performed: a skip of an intra modes test, or a test of a subset of intra modes instead of a full candidate list of intra modes for the current video block.

Clause 27. The method of clause 26, wherein the subset of intra modes comprises one or more intra modes from the full candidate list of intra modes.

Clause 28. The method of any of clauses 1-27, wherein coding the current video block comprises encoding the current video block into a bitstream of the video.

Clause 29. A method for video processing, comprising: performing a pre-analysis for a current video block of a video, wherein at least one of: a pre-intra cost determination, a pre-inter cost determination, a pre-intra mode selection, or a pre-inter motion estimation is skipped for the current video block; and coding the current video block based on the pre-analysis.

Clause 30. The method of clause 29, wherein a pre-cost of the current video block is set to be a pre-cost of a neighboring block of the current video block, the pre-cost comprising at least one of a pre-intra cost or a pre-inter cost of the current video block.

Clause 31. The method of clause 30, wherein the pre-cost is set to be a minimum pre-intra cost or a minimum pre-inter cost of a plurality of neighboring blocks of the current video block.

Clause 32. The method of clause 30 or 31, wherein the pre-cost of the current video block is obtained from a neighboring block of the current video block, and the pre-cost is further adjusted for the current video block.

Clause 33. The method of any of clauses 30-32, wherein the pre-cost is adjusted by multiplying a factor, the factor being controlled by an encoder for encoding the current video block.

Clause 34. The method of any of clauses 29-33, wherein at least one of a pre-intra mode or a pre-inter motion vector of the current video block is determined from at least one neighboring block of the current video block.

Clause 35. The method of clause 34, wherein the at least one neighboring block comprises at least one of: a left neighboring block, an above neighboring block, a left-above neighboring block, or a right-above neighboring block.

Clause 36. The method of clause 34 or 35, wherein the pre-intra mode selection is skipped for the current video block, and a target pre-intra mode of the current video block is set to be an intra mode of at least one neighboring block of the current video block.

Clause 37. The method of clause 36, wherein a pre-intra cost is recalculated for the current video block.

Clause 38. The method of clause 37, wherein a distortion part of the pre-intra cost is recalculated for the current video block, and a rate part of the pre-intra cost is copied from the at least one neighboring block.

Clause 39. The method of any of clauses 34-38, wherein the pre-inter motion estimation is skipped for the current video block, and a target pre-inter motion vector is determined from at least one neighboring block of the current video block.

Clause 40. The method of clause 39, wherein a pre-inter cost is recalculated for the current video block.

Clause 41. The method of clause 40, wherein a distortion part of the pre-inter cost is recalculated for the current video block, and a rate part of the pre-inter cost is copied from the at least one neighboring block.

Clause 42. The method of any of clauses 29-41, wherein coding the current video block comprises encoding the current video block into a bitstream of the video.

Clause 43. A method for video processing, comprising: dividing a current frame of a video into a plurality of regions: performing a pre-analysis for the plurality of regions in parallel; and coding the current frame based on the pre-analysis.

Clause 44. The method of clause 43, wherein information of a first block in a first region of the plurality of regions is not used or referred to by a second block in a second region of the plurality of regions.

Clause 45. The method of clause 44, wherein the information comprises at least one of: an intra mode, a motion vector, a pre-intra cost, or a pre-inter cost.

Clause 46. The method of clause 45, wherein the intra mode comprises a most probably intra mode, or wherein the motion vector comprises a motion vector prediction, or wherein the pre-intra cost comprises a pre-intra distortion and a rate factor, or wherein the pre-inter cost comprises a pre-inter distortion and a rate factor.

Clause 47. The method of any of clauses 43-46, wherein a size of a region of the current video block is based on at least one of: a video resolution, a slice type, a tile group type, a picture type, a color component, a temporal layer identifier, a profile, a level, or a tier of a standard.

Clause 48. The method of any of clauses 43-47, wherein coding the current frame comprises encoding the current frame into a bitstream of the video.

Clause 49. The method of any of clauses 1-48, wherein an applying of the method is based on at least one of: a video resolution, a slice type, a tile group type, a picture type, a color component, a temporal layer identifier, a profile, a level, or a tier of a standard.

Clause 50. The method of any of clauses 1-49, wherein the method is applied to at least one of: a pre-analysis related variance, or a pre-analysis process in an encoder.

Clause 51. An apparatus for video processing comprising a processor and a non-transitory memory with instructions thereon, wherein the instructions upon execution by the processor, cause the processor to perform a method in accordance with any of clauses 1-50.

Clause 52. A non-transitory computer-readable storage medium storing instructions that cause a processor to perform a method in accordance with any of clauses 1-50.

Clause 53. A non-transitory computer-readable recording medium storing a bitstream of a video which is generated by a method performed by an apparatus for video processing, wherein the method comprises: determining pre-analysis information for a current video block of the video, the pre-analysis information comprising at least one of: at least one pre-intra mode, or at least one pre-inter motion vector; determining a coding mode for the current video block based on the pre-analysis information; and generating the bitstream based on the coding mode.

Clause 54. A method for storing a bitstream of a video, comprising: determining pre-analysis information for a current video block of the video, the pre-analysis information comprising at least one of: at least one pre-intra mode, or at least one pre-inter motion vector; determining a coding mode for the current video block based on the pre-analysis information; generating the bitstream based on the coding mode; and storing the bitstream in a non-transitory computer-readable recording medium.

Clause 55. A non-transitory computer-readable recording medium storing a bitstream of a video which is generated by a method performed by an apparatus for video processing, wherein the method comprises: performing a pre-analysis for a current video block of the video, wherein at least one of: a pre-intra cost determination, a pre-inter cost determination, a pre-intra mode selection, or a pre-inter motion estimation is skipped for the current video block; and generating the bitstream based on the pre-analysis.

Clause 56. A method for storing a bitstream of a video, comprising: performing a pre-analysis for a current video block of the video, wherein at least one of: a pre-intra cost determination, a pre-inter cost determination, a pre-intra mode selection, or a pre-inter motion estimation is skipped for the current video block; generating the bitstream based on the pre-analysis; and storing the bitstream in a non-transitory computer-readable recording medium.

Clause 57. A non-transitory computer-readable recording medium storing a bitstream of a video which is generated by a method performed by an apparatus for video processing, wherein the method comprises: dividing a current frame of a video into a plurality of regions; performing a pre-analysis for the plurality of regions in parallel; and generating the bitstream based on the pre-analysis.

Clause 58. A method for storing a bitstream of a video, comprising: dividing a current frame of a video into a plurality of regions; performing a pre-analysis for the plurality of regions in parallel; generating the bitstream based on the pre-analysis; and storing the bitstream in a non-transitory computer-readable recording medium.

### Example Device

FIG. 22 illustrates a block diagram of a computing device 2200 in which various embodiments of the present disclosure can be implemented. The computing device 2200 may be implemented as or included in the source device 110 (or the video encoder 114 or 200) or the destination device 120 (or the video decoder 124 or 300).

It would be appreciated that the computing device 2200 shown in FIG. 22 is merely for purpose of illustration, without suggesting any limitation to the functions and scopes of the embodiments of the present disclosure in any manner.

As shown in FIG. 22, the computing device 2200 includes a general-purpose computing device 2200. The computing device 2200 may at least comprise one or more processors or processing units 2210, a memory 2220), a storage unit 2230), one or more communication units 2240, one or more input devices 2250, and one or more output devices 2260.

In some embodiments, the computing device 2200 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet. Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2200 can support any type of interface to a user (such as “wearable” circuitry and the like).

The processing unit 2210 may be a physical or virtual processor and can implement various processes based on programs stored in the memory 2220. In a multi-processor system, multiple processing units execute computer executable instructions in parallel so as to improve the parallel processing capability of the computing device 2200. The processing unit 2210 may also be referred to as a central processing unit (CPU), a microprocessor, a controller or a microcontroller.

The computing device 2200 typically includes various computer storage medium. Such medium can be any medium accessible by the computing device 2200, including, but not limited to, volatile and non-volatile medium, or detachable and non-detachable medium. The memory 2220 can be a volatile memory (for example, a register, cache, Random Access Memory (RAM)), a non-volatile memory (such as a Read-Only Memory (ROM). Electrically Erasable Programmable Read-Only Memory (EEPROM), or a flash memory), or any combination thereof. The storage unit 2230 may be any detachable or non-detachable medium and may include a machine-readable medium such as a memory, flash memory drive, magnetic disk or another other media, which can be used for storing information and/or data and can be accessed in the computing device 2200.

The computing device 2200 may further include additional detachable/non-detachable, volatile/non-volatile memory medium. Although not shown in FIG. 22, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2240) communicates with a further computing device via the communication medium. In addition, the functions of the components in the computing device 2200 can be implemented by a single computing cluster or multiple computing machines that can communicate via communication connections. Therefore, the computing device 2200 can operate in a networked environment using a logical connection with one or more other servers, networked personal computers (PCs) or further general network nodes.

The input device 2250 may be one or more of a variety of input devices, such as a mouse, keyboard, tracking ball, voice-input device, and the like. The output device 2260 may be one or more of a variety of output devices, such as a display, loudspeaker, printer, and the like. By means of the communication unit 2240, the computing device 2200 can further communicate with one or more external devices (not shown) such as the storage devices and display device, with one or more devices enabling the user to interact with the computing device 2200, or any devices (such as a network card, a modem and the like) enabling the computing device 2200 to communicate with one or more other computing devices, if required. Such communication can be performed via input/output (I/O) interfaces (not shown).

In some embodiments, instead of being integrated in a single device, some or all components of the computing device 2200 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2200 may be used to implement video encoding/decoding in embodiments of the present disclosure. The memory 2220 may include one or more video coding modules 2225 having one or more program instructions. These modules are accessible and executable by the processing unit 2210 to perform the functionalities of the various embodiments described herein.

In the example embodiments of performing video encoding, the input device 2250 may receive video data as an input 2270 to be encoded. The video data may be processed, for example, by the video coding module 2225, to generate an encoded bitstream. The encoded bitstream may be provided via the output device 2260 as an output 2280.

In the example embodiments of performing video decoding, the input device 2250 may receive an encoded bitstream as the input 2270. The encoded bitstream may be processed, for example, by the video coding module 2225, to generate decoded video data. The decoded video data may be provided via the output device 2260 as the output 2280.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining pre-analysis information for a current video block of a video, the pre-analysis information comprising at least one of: at least one pre-intra mode, or at least one pre-inter motion vector;
determining a coding mode for the current video block based on the pre-analysis information; and
coding the current video block based on the coding mode.

2. The method of claim 1, wherein a size of the current video block is less than or equal to a threshold size, and the at least one pre-intra mode comprises a pre-intra mode, priority of the pre-intra mode is higher than a further candidate intra mode.

3. The method of claim 2, wherein a plurality of candidate intra modes is available for the current video block, and the plurality of candidate intra modes comprises a subset of a whole sets of intra modes,
wherein the subset of intra modes comprises the pre-intra mode and at least one adjacent intra mode of the pre-intra mode,
wherein if the pre-intra mode is DC mode or PLANAR mode, the subset of intra modes only comprises at least one of: the DC mode, or the PLANAR mode, and/or
wherein a priority of the pre-intra mode is highest among a plurality of candidate intra modes of the current video block.

4. The method of claim 1, wherein a size of the current video block is less than or equal to a threshold size, and at least one priority of the at least one pre-inter motion vector is higher than a further inter motion vector candidate,
wherein an initial search list in a motion estimation for the current video block comprises the at least one pre-inter motion vector, or
wherein the pre-inter motion vector is a target motion vector for the current video block.

5. The method of claim 1, wherein the coding mode determined based on the pre-analysis information comprises a pre-analysis mode, the pre-analysis mode is tested before a further coding mode during the coding of the current video block.

6. The method of claim 5, wherein the further coding mode is not tested, or
wherein an early termination is checked after checking the pre-analysis mode, and during the early termination checking, if a rate distortion cost is less than a threshold, the mode checking for the current video block is terminated, and if the rate distortion cost is greater than or equal to the threshold, remaining modes are checked.

7. The method of claim 1, wherein a size of the current video block is greater than a threshold size, and the at least one pre-intra mode comprises a plurality of pre-intra modes for a plurality of subblocks of the current video block, a size of a subblock being less than or equal to the threshold size.

8. The method of claim 7, wherein the plurality of pre-intra modes is used as target intra modes for the current video block, or
wherein at least one of the plurality of pre-intra modes with a highest occurrence among the plurality of pre-intra modes is used as at least one target intra mode for the current video block.

9. The method of claim 8, wherein a plurality of candidate intra modes is available for the current video block, and the plurality of candidate intra modes comprises a subset of a whole sets of intra modes, and wherein the subset of intra modes comprises at least one of the plurality of pre-intra modes.

10. The method of claim 9, wherein the subset of intra modes further comprises at least one adjacent intra mode of the at least one of the plurality of pre-intra modes, or
wherein if the at least one of the plurality of pre-intra modes comprises DC mode or PLANAR mode, the subset of intra modes only comprises at least one of: the DC mode, or the PLANAR mode.

11. The method of claim 1, wherein a size of the current video block is greater than a threshold size, and the at least one pre-inter motion vector comprises a plurality of pre-inter motion vectors for a plurality of subblocks of the current video block.

12. The method of claim 11, wherein the plurality of pre-inter motion vectors is used as at least one target motion vector for the current video block, or
wherein at least one of the plurality of pre-inter motion vectors with a highest occurrence among the plurality of pre-inter motion vectors is used as the at least one target motion vector for the current video block, or
wherein at least one pre-inter motion vector closest to the current video block among the plurality of pre-inter motion vectors is used as the at least one target motion vector for the current video block.

13. The method of claim 12, wherein an initial search list in a motion estimation for the current video block comprises at least one of the plurality of pre-inter motion vectors.

14. The method of claim 1, wherein the at least one pre-intra mode is applied to at least one of: intra luma coding, or intra chroma coding, and/or
wherein the at least one pre-inter motion vector is scaled before being applied to an encoding process.

15. The method of claim 1, wherein the pre-analysis information further comprises at least one of: a pre-intra cost, or a pre-inter cost, and at least one of the pre-intra cost or the pre-inter cost is used to guide the coding of the current video block,
wherein a size of the current video block is less than or equal to a threshold size, and the pre-intra cost and the pre-inter cost is determined based on an intra pre-analysis and an inter pre-analysis performed on the current video block, or
wherein a size of the current video block is greater than a threshold size, the pre-intra cost is a sum of a plurality of pre-intra costs of a plurality of subblocks in the current video block, and the pre-inter cost is a sum of a plurality of pre-inter costs of the plurality of subblocks in the current video block.

16. The method of claim 15 wherein for the current video block, if the pre-inter cost is larger than the pre-intra cost, at least one of the following processes is performed: a skip of a skip modes test, a skip of an early-skip check, a skip of an inter-modes test, a skip of a non-square inter modes test, a skip of a merge-modes test, a skip of a half-pel motion estimation, a skip of a quarter-pel motion estimation, or only test intra coding, or
wherein for the current video block, if the pre-inter cost is smaller than the pre-intra cost, at least one of the following processes is performed; a skip of an intra modes test, or a test of a subset of intra modes instead of a full candidate list of intra modes for the current video block, wherein the subset of intra modes comprises one or more intra modes from the full candidate list of intra modes.

17. The method of claim 1, wherein coding the current video block comprises encoding the current video block into a bitstream of the video.

18. An apparatus for video processing comprising a processor and a non-transitory memory with instructions thereon, wherein the instructions upon execution by the processor, cause the processor to:
determine pre-analysis information for a current video block of a video, the pre-analysis information comprising at least one of: at least one pre-intra mode, or at least one pre-inter motion vector;
determine a coding mode for the current video block based on the pre-analysis information; and
code the current video block based on the coding mode.

19. A non-transitory computer-readable storage medium storing instructions that cause a processor to perform acts comprising:
determining pre-analysis information for a current video block of a video, the pre-analysis information comprising at least one of: at least one pre-intra mode, or at least one pre-inter motion vector;
determining a coding mode for the current video block based on the pre-analysis information; and
coding the current video block based on the coding mode.

20. A non-transitory computer-readable recording medium storing a bitstream of a video which is generated by a method performed by an apparatus for video processing, wherein the method comprises:
determining pre-analysis information for a current video block of the video, the pre-analysis information comprising at least one of: at least one pre-intra mode, or at least one pre-inter motion vector;
determining a coding mode for the current video block based on the pre-analysis information; and
generating the bitstream based on the coding mode.
